(19) United States
(12) Patent Application Publication
(10) Pub. No.: US 2026/0065844 A1
(43) Pub. Date: Mar. 5, 2026

(54) DISPLAY APPARATUS AND ELECTRONIC APPARATUS INCLUDING THE SAME

(71) Applicant: Samsung Display Co., Ltd., Yongin-Si (KR)

(72) Inventors: JIN-WOOK YANG, Yongin-si (KR); BON-SEOG GU, Yongin-si (KR); JINYOUNG ROH, Yongin-si (KR); YOUNGHA SOHN, Yongin-si (KR); JAE-HYEON JEON, Yongin-si (KR); EUI-MYEONG CHO, Yongin-si (KR)

(21) Appl. No.: 19/216,838

(22) Filed: May 23, 2025

(30) Foreign Application Priority Data
Aug. 28, 2024 (KR) 10-2024-0116040

(51) Int. Cl. G09G 3/32

(52) U.S. Cl. CPC G09G 3/32; G09G 2300/043; G09G 2300/0819; G09G 2310/0275; G09G 2310/08; G09G 2320/0233; G09G 2330/023; G09G 2330/028

(57) ABSTRACT

A display includes a display panel, a data driver and a power voltage generator. The display panel includes a pixel configured to emit a light based on a first power voltage and a second power voltage less than the first power voltage. The data driver is configured to output a data voltage to the pixel. The power voltage generator is configured to output a data power voltage, a maximum data voltage and a minimum data voltage to the data driver. A luminance setting value varies, the data power voltage and the maximum data voltage are varied, and the minimum data voltage is fixed.

### PRIORITY STATEMENT

This application claims priority under 35 U.S.C. § 119 to Korean Patent Application No. 10-2024-0116040, filed on Aug. 28, 2024 in the Korean Intellectual Property Office KIPO, the contents of which are herein incorporated by reference in their entireties.

### BACKGROUND

### 1. Field

Embodiments of the present inventive concept relate to a display apparatus and an electronic apparatus including the display apparatus. More particularly, embodiments of the present inventive concept relate to a display apparatus reducing a power consumption and an electronic apparatus including the display apparatus.

### 2. Description of the Related Art

Generally, a display apparatus includes a display panel and a display panel driver. The display panel includes a plurality of gate lines, a plurality of data lines, a plurality of emission lines and a plurality of pixels. The display panel driver includes a gate driver, a data driver, an emission driver and a driving controller. The gate driver outputs gate signals to the gate lines. The data driver outputs data voltages to the data lines. The emission driver outputs emission signals to the emission lines. The driving controller controls an operation of the gate driver, an operation of the data driver and an operation of the emission driver.

In a conventional pixel, a driving current is determined proportionally to a square of a difference between a high power voltage and the data voltage. In the conventional pixel, the data voltage may decrease as image data becomes whiter (brighter) and the data voltage may increase as the image data becomes blacker (darker). It may be difficult to control the high power voltage quickly and changes of the high power voltage may affect the display image. Accordingly, the high power voltage may be fixed in the conventional pixel even if a luminance setting value of the display apparatus and a luminance mode of the display apparatus changes. When the high power voltage is fixed, a black data voltage may be fixed and a data power voltage applied to the data driver may also be fixed.

In this case, even if the luminance setting value is relatively low or the luminance mode is a low luminance mode, the high power voltage, the black data voltage and the data power voltage may be fixed. Thus, a power consumption of the display apparatus may be high.

### SUMMARY

Embodiments of the present inventive concept provide a display apparatus reducing a power consumption by varying a data power voltage and a maximum data voltage according to a luminance setting value or a luminance mode.

Embodiments of the present inventive concept also provide an electronic apparatus including the display apparatus.

In an embodiment of a display apparatus according to the present inventive concept, the display apparatus includes a display panel, a data driver and a power voltage generator. The display panel includes a pixel configured to emit a light based on a first power voltage and a second power voltage less than the first power voltage. The data driver is configured to output a data voltage to the pixel. The power voltage generator is configured to output a data power voltage, a maximum data voltage and a minimum data voltage to the data driver. A luminance setting value varies, the data power voltage and the maximum data voltage are varied, and the minimum data voltage is fixed.

In an embodiment, the luminance setting value varies, and a difference between the data power voltage and the maximum data voltage may be fixed.

In an embodiment, the data power voltage may be greater than the maximum data voltage.

In an embodiment, the luminance setting value varies, and a difference between a reference voltage applied to the pixel and the minimum data voltage may be fixed.

In an embodiment, the reference voltage may be different from the first power voltage. The reference voltage may be different from the second power voltage.

In an embodiment, the reference voltage may be greater than the minimum data voltage.

In an embodiment, the minimum data voltage may be greater than the second power voltage.

In an embodiment, the maximum data voltage may be greater than a white data voltage corresponding to a maximum grayscale value at the luminance setting value.

In an embodiment, the luminance setting value varies, and a difference between the maximum data voltage and the white data voltage may be fixed.

In an embodiment, the minimum data voltage may be substantially the same as a black data voltage corresponding to a minimum grayscale value.

In an embodiment, the pixel may include a light emitting element and a first transistor configured to apply a driving current to the light emitting element. The first transistor may be an N-type transistor.

In an embodiment, the driving current of the pixel may be proportional to a square of a difference between the data voltage and a reference voltage applied to the pixel.

In an embodiment, the pixel may include the first transistor including a control electrode connected to a first node, a first electrode connected to a second node and a second electrode connected to a third node, a second transistor including a control electrode configured to receive a writing gate signal, a first electrode configured to receive the data voltage and a second electrode connected to the first node, a third transistor including a control electrode configured to receive a reference gate signal, a first electrode configured to receive a reference voltage and a second electrode connected to the first node, a fourth transistor including a control electrode configured to receive an initialization gate signal, a first electrode configured to receive an initialization voltage and a second electrode connected to an anode electrode of the light emitting element, a fifth transistor including a control electrode configured to receive a first emission signal, a first electrode configured to receive the first power voltage and a second electrode connected to the second node, a sixth transistor including a control electrode configured to receive a second emission signal, a first electrode connected to the third node and a second electrode connected to the anode electrode of the light emitting element, the light emitting element including the anode electrode and a cathode electrode configured to receive the second power voltage, a first capacitor including a first electrode connected to the first node and a second electrode connected to the third node and a second capacitor including a first electrode configured to receive the first power voltage and a second electrode connected to the third node.

In an embodiment, the second transistor, the third transistor and the fourth transistor may be N-type transistors. At least one of the fifth transistor and the sixth transistor may be P-type transistor.

In an embodiment, the second transistor, the third transistor, the fourth transistor, the fifth transistor and the sixth transistor may be N-type transistors.

In an embodiment, the first emission signal may have an inactive level in a first period. The second emission signal may have an active level in the first period. The reference gate signal may have an active level in the first period. The initialization gate signal may have an active level in the first period. The writing gate signal may have an inactive level in the first period. The first emission signal may have an active level in a second period subsequent to the first period. The second emission signal may have an inactive level in the second period. The reference gate signal may have the active level in the second period. The initialization gate signal may have the active level in the second period. The writing gate signal may have the inactive level in the second period. The first emission signal may have the inactive level in a third period subsequent to the second period. The second emission signal may have the inactive level in the third period. The reference gate signal may have an inactive level in the third period. The initialization gate signal may have the active level in the third period. The writing gate signal may have an active level in the third period. The first emission signal may have the active level in a fourth period subsequent to the third period. The second emission signal may have the active level in the fourth period. The reference gate signal may have the inactive level in the fourth period. The initialization gate signal may have the inactive level in the fourth period. The writing gate signal may have the inactive level in the fourth period.

In an embodiment, the display apparatus may further include a driving controller configured to control an operation of the data driver and an operation of the power voltage generator. The driving controller may be configured to output the luminance setting value to the power voltage generator.

In an embodiment, the driving controller and the data driver may be integratedly formed to form an integrated driver. The integrated driver may be configured to output the luminance setting value to the power voltage generator. The power voltage generator may be configured to output the data power voltage, the maximum data voltage and the minimum data voltage to the integrated driver.

In an embodiment of a display apparatus according to the present inventive concept, the display apparatus includes a display panel, a data driver and a power voltage generator. The display panel includes a pixel configured to emit a light based on a first power voltage and a second power voltage less than the first power voltage. The data driver is configured to output a data voltage to the pixel. The power voltage generator is configured to output a data power voltage, a maximum data voltage and a minimum data voltage to the data driver. A luminance mode varies, the data power voltage and the maximum data voltage are varied, and the minimum data voltage is fixed.

In an embodiment of an electronic apparatus according to the present inventive concept, the electronic apparatus includes a display panel, a data driver, a power voltage generator, a driving controller and a processor. The display panel includes a pixel configured to emit a light based on a first power voltage and a second power voltage less than the first power voltage. The data driver is configured to output a data voltage to the pixel. The power voltage generator is configured to output a data power voltage, a maximum data voltage and a minimum data voltage to the data driver. The driving controller is configured to control an operation of the data driver and an operation of the power voltage generator. The processor is configured to output an input control signal and input image data to the driving controller. A luminance setting value varies, the data power voltage and the maximum data voltage are varied, and the minimum data voltage is fixed.

According to the display apparatus and the electronic apparatus including the display apparatus, the driving current of the pixel may be determined proportionally to the square of the difference between the data voltage and the reference voltage, the data voltage may increase as image data becomes whiter (brighter) and the data voltage may decrease as the image data becomes blacker (darker).

The data power voltage and the maximum data voltage may be varied according to the luminance setting value or the luminance mode of the display apparatus and the minimum data voltage may be fixed regardless of the luminance setting value or the luminance mode of the display apparatus.

The data power voltage and the maximum data voltage are varied according to the luminance setting value or the luminance mode so that the white data voltage and the data power voltage may be set relatively low when the luminance setting value is relatively low or the luminance mode is a low luminance mode. Thus, the power consumption of the display apparatus may be reduced.

### BRIEF DESCRIPTION OF THE DRAWINGS

The above and other features and advantages of the present inventive concept will become more apparent by describing in detailed embodiments thereof with reference to the accompanying drawings.

FIG. 1 is a block diagram illustrating a display apparatus according to an embodiment of the present inventive concept.

FIG. 2 is a circuit diagram illustrating a pixel of a display panel of FIG. 1.

FIG. 3 is a timing diagram illustrating input signals applied to the pixel of FIG. 2.

FIG. 4 is a circuit diagram illustrating an operation of the pixel of FIG. 2 in a first period.

FIG. 5 is a circuit diagram illustrating the input signals applied to the pixel of FIG. 4 in the first period.

FIG. 6 is a circuit diagram illustrating an operation of the pixel of FIG. 2 in a second period.

FIG. 7 is a circuit diagram illustrating the input signals applied to the pixel of FIG. 6 in the second period.

FIG. 8 is a circuit diagram illustrating an operation of the pixel of FIG. 2 in a third period.

FIG. 9 is a circuit diagram illustrating the input signals applied to the pixel of FIG. 8 in the third period.

FIG. 10 is a circuit diagram illustrating an operation of the pixel of FIG. 2 in a fourth period.

FIG. 11 is a circuit diagram illustrating the input signals applied to the pixel of FIG. 10 in the fourth period.

FIG. 12 is a diagram illustrating a data power voltage, a maximum data voltage, a minimum data voltage, a first power voltage, a second power voltage and a reference voltage when the luminance setting value of the display apparatus of FIG. 1 is a first value.

FIG. 13 is a diagram illustrating the data power voltage, the maximum data voltage, the minimum data voltage, the first power voltage, the second power voltage and the reference voltage when the luminance setting value of the display apparatus of FIG. 1 is a second value.

FIG. 14 is a diagram illustrating the data power voltage, the maximum data voltage, the minimum data voltage, the first power voltage, the second power voltage and the reference voltage when the luminance setting value of the display apparatus of FIG. 1 is a third value.

FIG. 15 is a diagram illustrating the data power voltage, the maximum data voltage, the minimum data voltage, the first power voltage, the second power voltage and the reference voltage when the luminance setting value of the display apparatus of FIG. 1 is a fourth value.

FIG. 16 is a diagram illustrating a setting of a gamma lookup table according to the luminance setting value of the display apparatus of FIG. 1.

FIG. 17 is a diagram illustrating an example of a driving timing of the display panel of FIG. 1.

FIG. 18 is a diagram illustrating an example of a driving timing of the display panel of FIG. 1.

FIG. 19 is a circuit diagram illustrating a pixel of a display panel of a display apparatus according to an embodiment of the present inventive concept.

FIG. 20 is a timing diagram illustrating input signals applied to the pixel of FIG. 19.

FIG. 21 is a block diagram illustrating a display apparatus according to an embodiment of the present inventive concept.

FIG. 22 is a block diagram illustrating an electronic apparatus according to an embodiment of the present inventive concept.

FIG. 23 is a diagram illustrating an example in which the electronic apparatus of FIG. 22 is implemented as a smartphone.

FIG. 24 is a diagram illustrating an example in which the electronic apparatus of FIG. 22 is implemented as a monitor.

### DETAILED DESCRIPTION OF THE INVENTIVE CONCEPT

Hereinafter, the present inventive concept will be explained in detail with reference to the accompanying drawings.

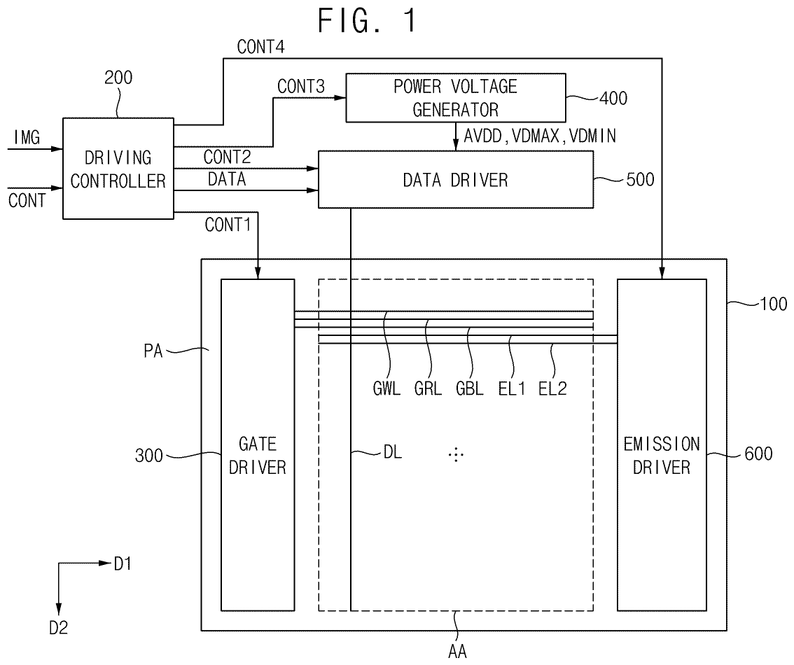

FIG. 1 is a block diagram illustrating a display apparatus according to an embodiment of the present inventive concept.

Referring to FIG. 1, the display apparatus includes a display panel 100 and a display panel driver. The display panel driver includes a driving controller 200, a gate driver 300, a power voltage generator 400, a data driver 500 and an emission driver 600.

The display panel 100 has a display region AA on which an image is displayed and a peripheral region PA adjacent to the display region AA.

The display panel 100 includes a plurality of gate lines GWL, GRL and GBL, a plurality of data lines DL, a plurality of emission lines EL1 and EL2 and a plurality of pixels electrically connected to the gate lines GWL, GRL and GBL, the data lines DL and the emission lines EL1 and EL2. The gate lines GWL, GRL and GBL may extend in a first direction D1, the data lines DL may extend in a second direction D2 crossing the first direction D1 and the emission lines EL1 and EL2 may extend in the first direction D1.

The driving controller 200 may receive input image data IMG and an input control signal CONT from an external apparatus. For example, the driving controller 200 may receive the input image data IMG and the input control signal CONT from a host or an application processor. For example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal. The input control signal CONT may further include a luminance setting value. The luminance setting value may mean a luminance value corresponding to a maximum grayscale value of the input image data IMG. The luminance setting value may be set by a user or automatically determined by an ambient luminance.

The driving controller 200 generates a first control signal CONT1, a second control signal CONT2, a third control signal CONT3, a fourth control signal CONT4 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the power voltage generator 400 based on the input control signal CONT, and output the third control signal CONT3 to the power voltage generator 400.

The driving controller 200 generates the fourth control signal CONT4 for controlling an operation of the emission driver 600 based on the input control signal CONT, and outputs the fourth control signal CONT4 to the emission driver 600.

The gate driver 300 may generate gate signals driving the gate lines GWL, GRL and GBL in response to the first control signal CONT1 received from the driving controller 200. The gate driver 300 may output the gate signals to the gate lines GWL, GRL and GBL. For example, the gate driver 300 may be integrated on the peripheral region PA of the display panel 100. For example, the gate driver 300 may be mounted on the peripheral region PA of the display panel 100.

The power voltage generator 400 may generate a power voltage in response to the third control signal CONT3 received from the driving controller 200. The power voltage generator 400 may provide the power voltage to the data driver 500. For example, the power voltage generator 400 may output a data power voltage AVDD, a maximum data voltage VDMAX and a minimum data voltage VDMIN.

For example, the power voltage generator 400 may be formed as an integrated circuit which is independent from the data driver 500. In an embodiment, the power voltage generator 400 may be disposed in the driving controller 200, or in the data driver 500.

The data driver 500 may receive the second control signal CONT2 and the data signal DATA from the driving controller 200, and receive a gamma reference voltage from a gamma reference voltage generator. The data driver 500 may convert the data signal DATA into data voltages having an analog type using the gamma reference voltage. The data driver 500 may output the data voltages to the data lines DL.

The maximum data voltage VDMAX may mean a maximum value of the data voltage generated by the data driver 500 at a specific luminance setting value. The minimum data voltage VDMIN may mean a minimum value of the data voltage generated by the data driver 500 at the specific luminance setting value. The maximum data voltage VDMAX may be a base of a data voltage for a maximum grayscale value. The minimum data voltage VDMIN may be a base of a data voltage for a minimum grayscale value. The data voltage for the maximum grayscale value may be a white data voltage. The data voltage for the minimum grayscale value may be a black data voltage. When the data signal has a value of eight bits, the maximum grayscale value may be 255 and the minimum grayscale value may be zero.

In the present embodiment, the white data voltage may be greater than the black data voltage. In the present embodiment, the data voltage representing a high grayscale value may be greater than the data voltage representing a low grayscale value.

The emission driver 600 may generate emission signals to drive the emission lines EL1 and EL2 in response to the fourth control signal CONT4 received from the driving controller 200. The emission driver 600 may output the emission signals to the emission lines EL1 and EL2. For example, the emission driver 600 may be integrated on the peripheral region PA of the display panel 100. For example, the emission driver 600 may be mounted on the peripheral region PA of the display panel 100.

Although the gate driver 300 is disposed at a first side of the display panel 100 and the emission driver 600 is disposed at a second side of the display panel 100 opposite to the first side in FIG. 1 for convenience of explanation, the present inventive concept may not be limited thereto. For example, both of the gate driver 300 and the emission driver 600 may be disposed at the first side of the display panel 100. For example, both of the gate driver 300 and the emission driver 600 may be disposed at the second side of the display panel 100. For example, the gate driver 300 and the emission driver 600 may be integratedly formed.

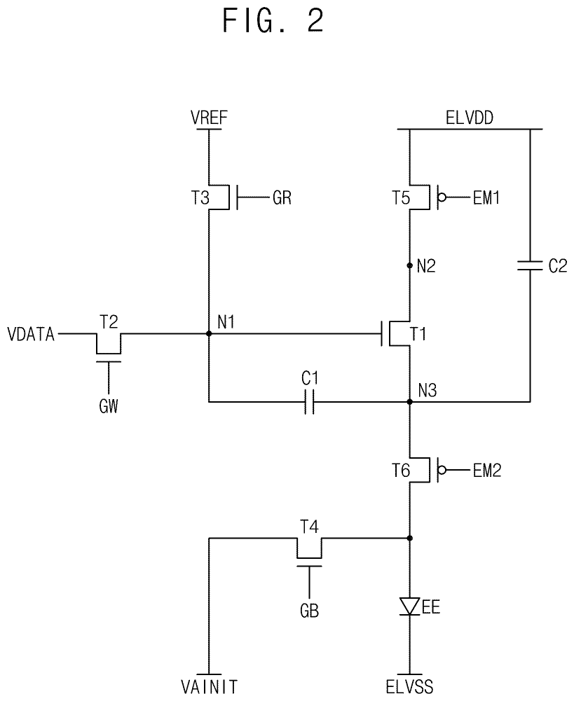

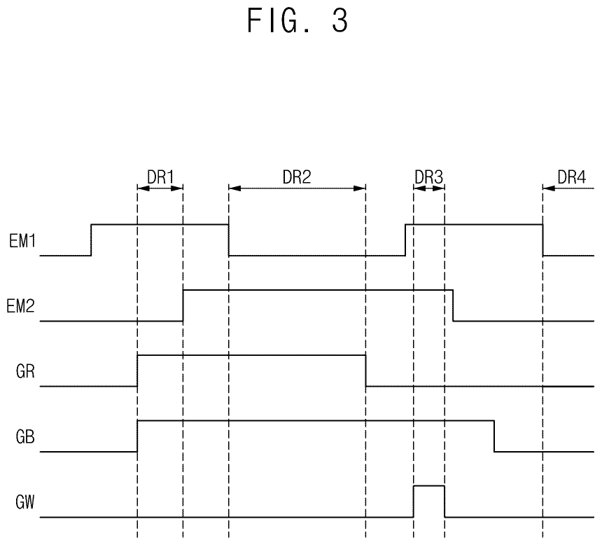

FIG. 2 is a circuit diagram illustrating a pixel of the display panel 100 of FIG. 1. FIG. 3 is a timing diagram illustrating input signals applied to the pixel of FIG. 2.

Referring to FIGS. 1 to 3, the display panel 100 includes a plurality of pixels. Each of the pixels includes a light emitting element EE. The pixels may emit a light based on a first power voltage ELVDD and a second power voltage ELVSS less than the first power voltage ELVDD.

The pixel receives a writing gate signal GW, an initialization gate signal GB, a reference gate signal GR, a data voltage VDATA, a first emission signal EM1 and a second emission signal EM2 and the light emitting element EE emits a light according to a level of the data voltage VDATA to display an image.

The pixel includes the light emitting element EE and a first transistor T1 applying a driving current to the light emitting element EE. Herein, the first transistor T1 may be an N-type transistor. The first transistor T1 may be an oxide semiconductor thin film transistor.

The driving current of the pixel may be proportional to a square of a difference between the data voltage VDATA and a reference voltage VREF. The reference voltage VREF may be different from the first power voltage ELVDD. The reference voltage VREF may be different from the second power voltage ELVSS.

For example, the reference voltage VREF may be less than the white data voltage and greater than the black data voltage. For example, the reference voltage VREF may be less than the first power voltage ELVDD.

The pixel may include the first transistor T1, a second transistor T2, a third transistor T3, a fourth transistor T4, a fifth transistor T5, a sixth transistor T6, the light emitting element EE, a first capacitor C1 and a second capacitor C2. The first transistor T1 includes a control electrode connected to a first node N1, a first electrode connected to a second node N2 and a second electrode connected to a third node N3. The second transistor T2 includes a control electrode receiving the writing gate signal GW, a first electrode receiving the data voltage VDATA and a second electrode connected to the first node N1. The third transistor T3 includes a control electrode receiving the reference gate signal GR, a first electrode receiving the reference voltage VREF and a second electrode connected to the first node N1. The fourth transistor T4 includes a control electrode receiving the initialization gate signal GB, a first electrode receiving an initialization voltage VAINIT and a second electrode connected to an anode electrode of the light emitting element EE. The fifth transistor T5 includes a control electrode receiving the first emission signal EM1, a first electrode receiving the first power voltage ELVDD and a second electrode connected to the second node N2. The sixth transistor T6 includes a control electrode receiving the second emission signal EM2, a first electrode connected to the third node N3 and a second electrode connected to the anode electrode of the light emitting element EE. The light emitting element EE includes the anode electrode and a cathode electrode receiving the second power voltage ELVSS. The first capacitor C1 includes a first electrode connected to the first node N1 and a second electrode connected to the third node N3. The second capacitor C2 includes a first electrode receiving the first power voltage ELVDD and a second electrode connected to the third node N3.

In the present embodiment, the second transistor T2, the third transistor T3 and the fourth transistor T4 may be N-type transistors. The second transistor T2, the third transistor T3 and the fourth transistor T4 may be oxide semiconductor thin film transistors.

In the present embodiment, the fifth transistor T5 and the sixth transistor T6 may be P-type transistors. The fifth transistor T5 and the sixth transistor T6 may be low temperature polycrystalline silicon (“LTPS”) thin film transistors.

As shown in FIG. 3, a driving timing of the pixel may include a first period DR1, a second period DR2, a third period DR3 and a fourth period DR4. The first period DR1 may be an initialization period. The second period DR2 may be a threshold voltage compensation period. The third period DR3 may be a writing period. The fourth period DR4 may be a light emission period.

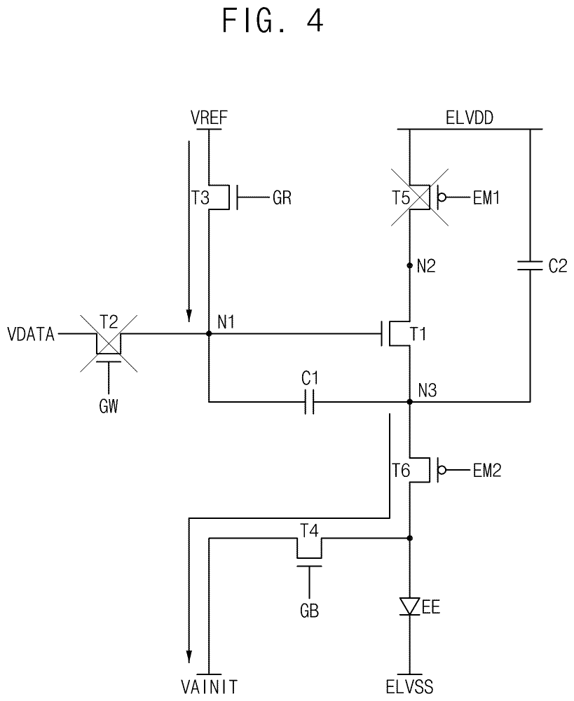

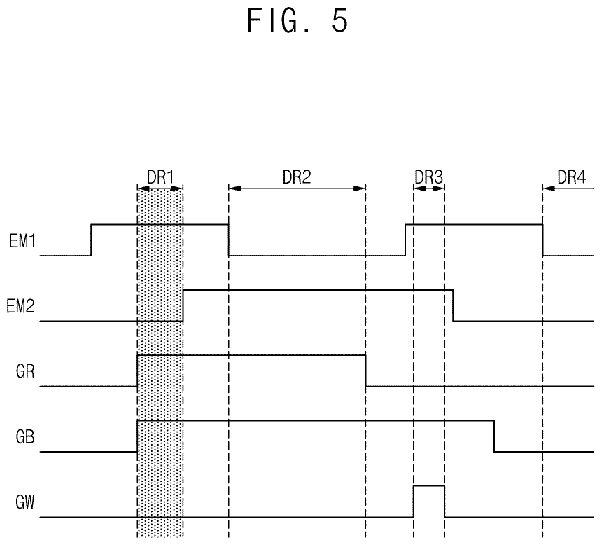

FIG. 4 is a circuit diagram illustrating an operation of the pixel of FIG. 2 in the first period DR1. FIG. 5 is a circuit diagram illustrating the input signals applied to the pixel of FIG. 4 in the first period DR1.

When the first emission signal EM1, the second emission signal EM2, the reference gate signal GR, the initialization gate signal GB and the writing gate signal GW are applied to P-type transistors, active levels of the first emission signal EM1, the second emission signal EM2, the reference gate signal GR, the initialization gate signal GB and the writing gate signal GW may be low levels and inactive levels of the first emission signal EM1, the second emission signal EM2, the reference gate signal GR, the initialization gate signal GB and the writing gate signal GW may be high levels.

In contrast, when the first emission signal EM1, the second emission signal EM2, the reference gate signal GR, the initialization gate signal GB and the writing gate signal GW are applied to N-type transistors, active levels of the first emission signal EM1, the second emission signal EM2, the reference gate signal GR, the initialization gate signal GB and the writing gate signal GW may be high levels and inactive levels of the first emission signal EM1, the second emission signal EM2, the reference gate signal GR, the initialization gate signal GB and the writing gate signal GW may be low levels.

Referring to FIGS. 1 to 5, in the first period DR1, the first emission signal EM1 may have an inactive level, the second emission signal EM2 may have an active level, the reference gate signal GR may have an active level, the initialization gate signal GB may have an active level and the writing gate signal GW may have an inactive level.

In the first period DR1, the second transistor T2 may be turned off, the third transistor T3 may be turned on, the fourth transistor T4 may be turned on, the fifth transistor T5 may be turned off and the sixth transistor T6 may be turned on.

In the first period DR1, the third transistor T3 is tuned on so that the reference voltage VREF may be applied to the first node N1.

In the first period DR1, the fourth transistor T4 and the sixth transistor T6 are turned on so that the initialization voltage VAINIT may be applied to the anode electrode of the light emitting element EE and the third node N3.

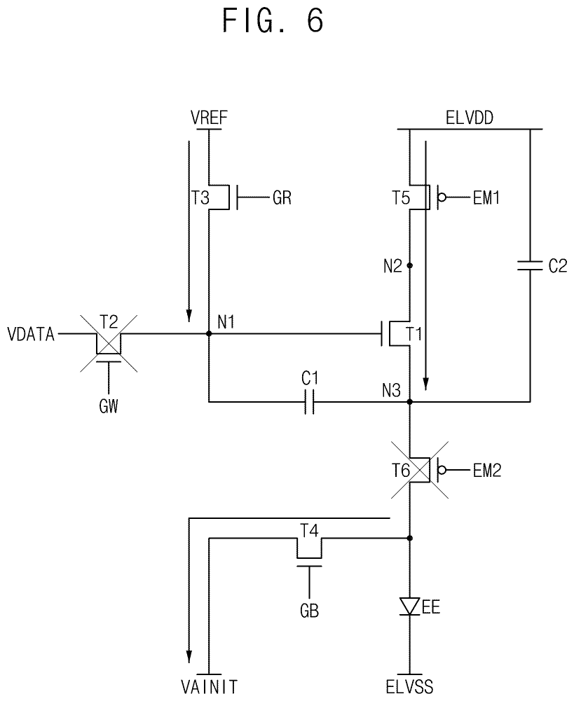

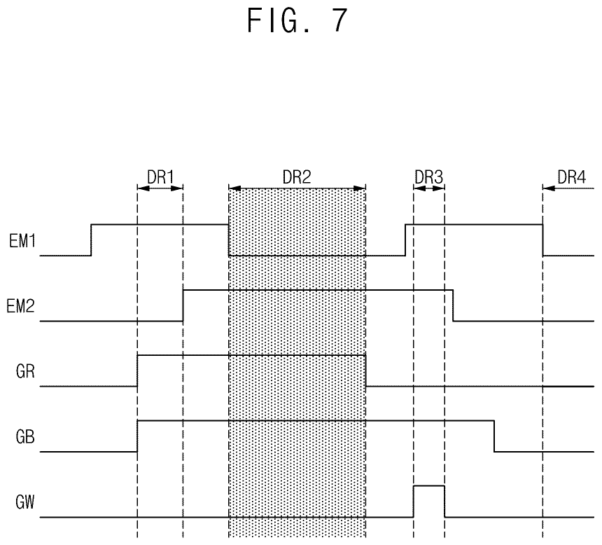

FIG. 6 is a circuit diagram illustrating an operation of the pixel of FIG. 2 in the second period DR2. FIG. 7 is a circuit diagram illustrating the input signals applied to the pixel of FIG. 6 in the second period DR2.

Referring to FIGS. 1 to 7, in the second period DR2, the first emission signal EM1 may have an active level, the second emission signal EM2 may have an inactive level, the reference gate signal GR may have the active level, the initialization gate signal GB may have the active level and the writing gate signal GW may have the inactive level.

In the second period DR2, the second transistor T2 may be turned off, the third transistor T3 may be turned on, the fourth transistor T4 may be turned on, the fifth transistor T5 may be turned on and the sixth transistor T6 may be turned off. In the second period DR2, the first transistor T1 may be turned on by the reference voltage VREF applied to the first node N1.

In the second period DR2, a turned-on state of the third transistor T3 is maintained and the reference voltage VREF may be applied to the first node N1.

In the second period DR2, a turned-on state of the fourth transistor T4 is maintained and the initialization voltage VAINIT may be applied to the anode electrode of the light emitting element EE.

In the second period DR2, the fifth transistor T5 and the first transistor T1 are turned on so that a voltage of the third node N3 may be a difference between the reference voltage VREF and a threshold voltage of the first transistor T1. A threshold voltage component of the first transistor T1 is applied to the third node N3 so that the second period DR2 may be referred to as the threshold voltage compensation period.

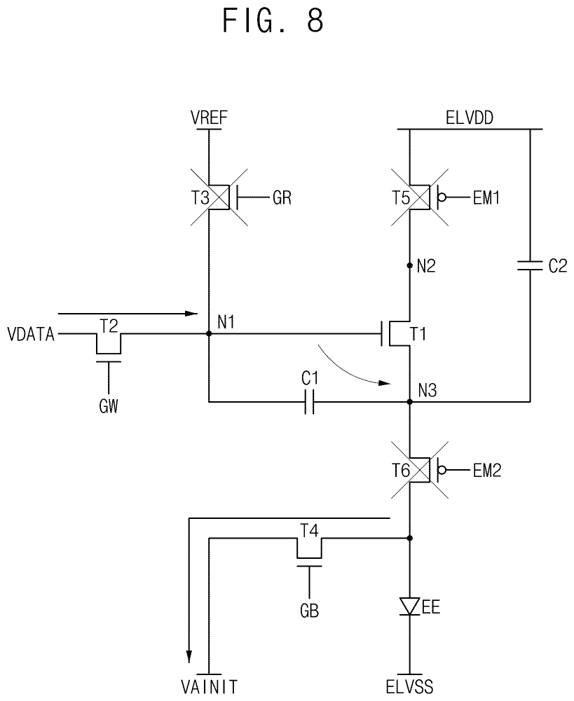

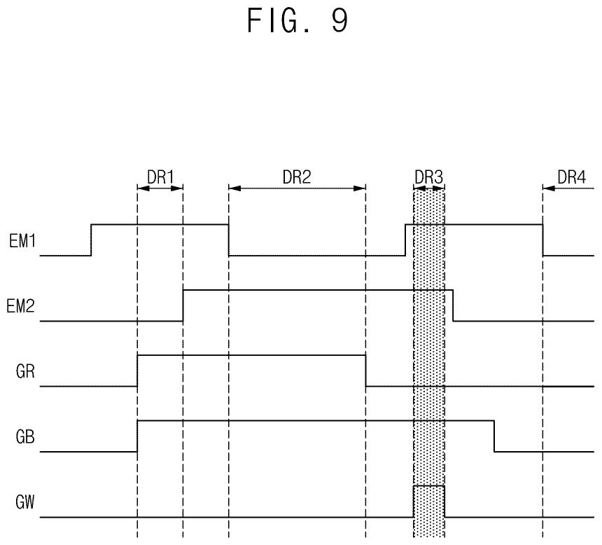

FIG. 8 is a circuit diagram illustrating an operation of the pixel of FIG. 2 in the third period DR3. FIG. 9 is a circuit diagram illustrating the input signals applied to the pixel of FIG. 8 in the third period DR3.

Referring to FIGS. 1 to 9, in the third period DR3, the first emission signal EM1 may have the inactive level, the second emission signal EM2 may have the inactive level, the reference gate signal GR may have an inactive level, the initialization gate signal GB may have the active level and the writing gate signal GW may have an active level.

In the third period DR3, the second transistor T2 may be turned on, the third transistor T3 may be turned off, the fourth transistor T4 may be turned on, the fifth transistor T5 may be turned off and the sixth transistor T6 may be turned off.

In the third period DR3, the second transistor T2 is turned on so that the data voltage VDATA may be applied to the first node N1 and the data voltage VDATA may be transmitted to the third node N3 by a coupling of the first capacitor C1.

The data voltage VDATA may be transmitted to the third node N3 according to a ratio (e.g. C1/(C1+C2)) of capacitances of the first capacitor C1 and the second capacitor C2.

In the third period DR3, the turned-on state of the fourth transistor T4 is maintained and the initialization voltage VAINIT may be applied to the anode electrode of the light emitting element EE.

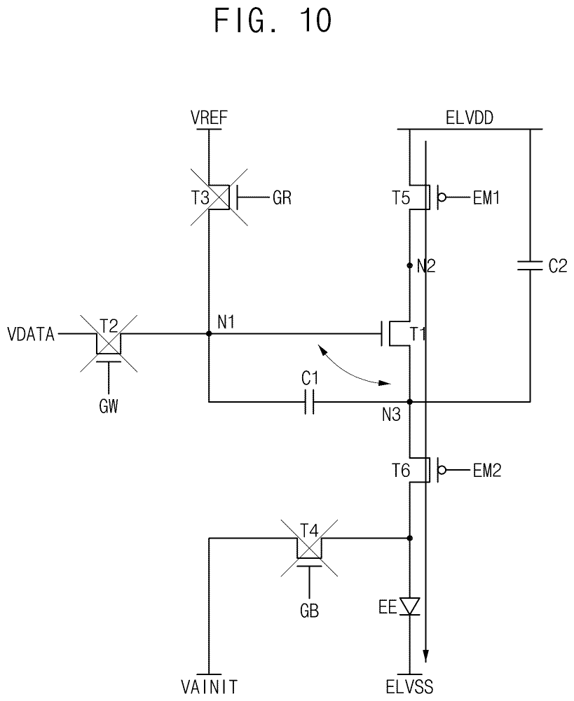

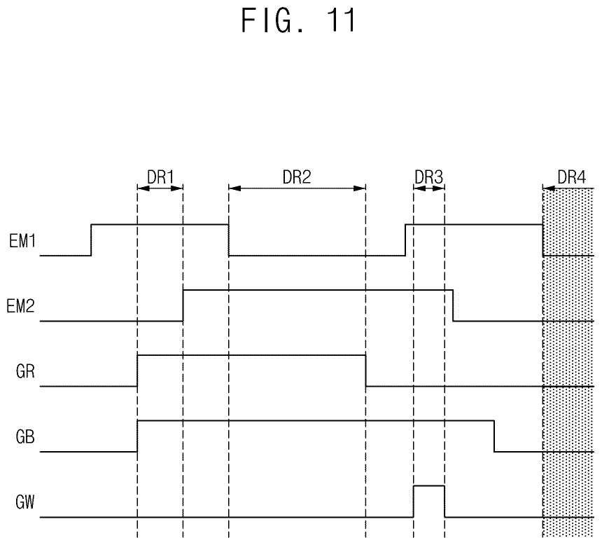

FIG. 10 is a circuit diagram illustrating an operation of the pixel of FIG. 2 in the fourth period DR4. FIG. 11 is a circuit diagram illustrating the input signals applied to the pixel of FIG. 10 in the fourth period DR4.

Referring to FIGS. 1 to 11, in the fourth period DR4, the first emission signal EM1 may have the active level, the second emission signal EM2 may have the active level, the reference gate signal GR may have the inactive level, the initialization gate signal GB may have an inactive level and the writing gate signal GW may have the inactive level.

In the fourth period DR4, the first transistor T1 may be turned on, the second transistor T2 may be turned off, the third transistor T3 may be turned off, the fourth transistor T4 may be turned off, the fifth transistor T5 may be turned on and the sixth transistor T6 may be turned on.

The driving current of the light emitting element EE may be represented as following Equation 1.

$$I = \frac{1}{2} μ Cox \frac{W}{L} \frac{C 2}{C 1 + C 2} {( VDATA - VREF )}^{2} \qquad [ Equation 1 ]$$

Herein, μ is a mobility, Cox is a capacitance between a gate and a channel, W is a width of the channel and L is a length of the channel.

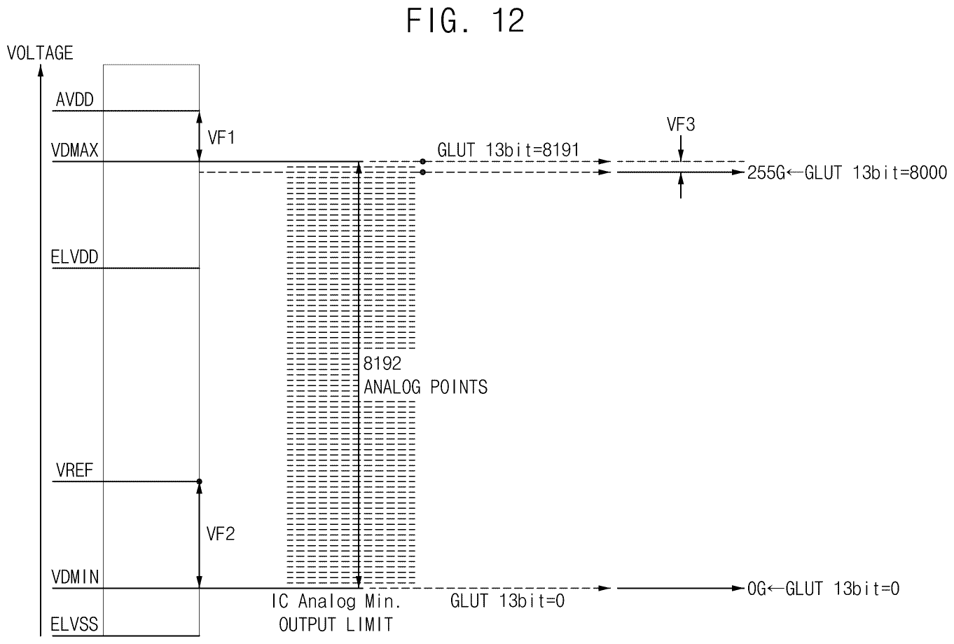

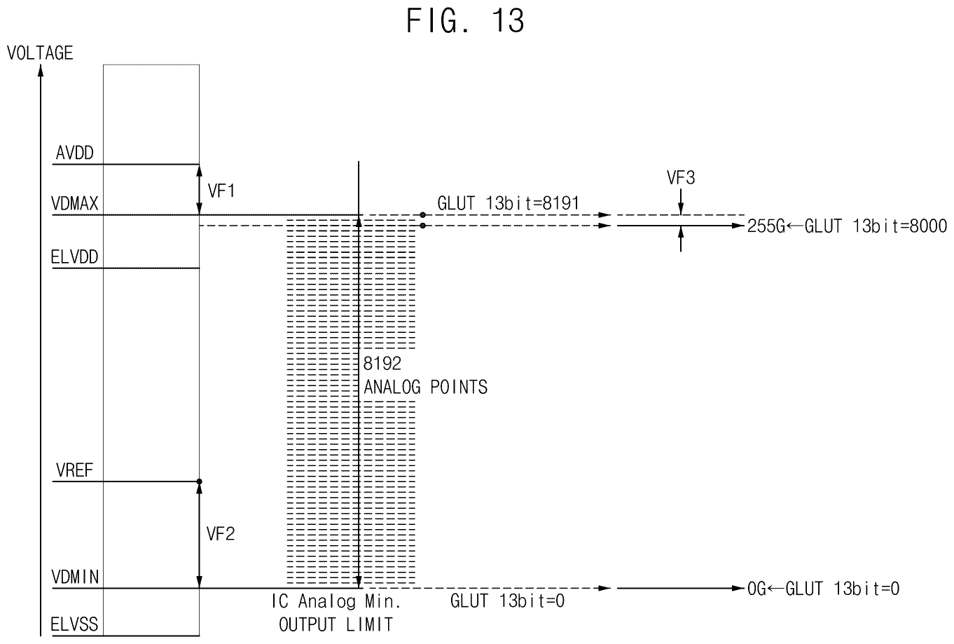

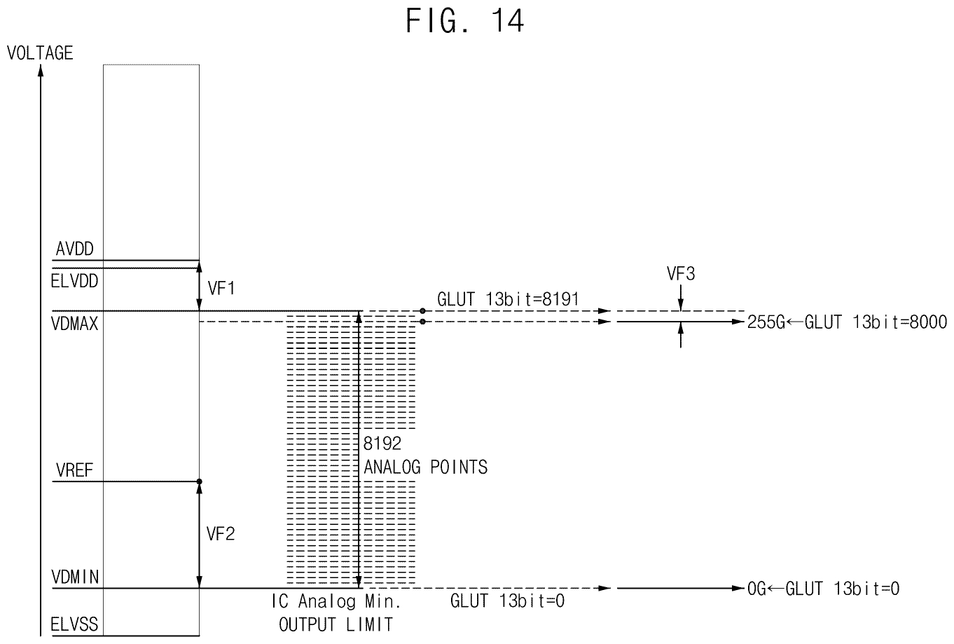

FIG. 12 is a diagram illustrating the data power voltage AVDD, the maximum data voltage VDMAX, the minimum data voltage VDMIN, the first power voltage ELVDD, the second power voltage ELVSS and the reference voltage VREF when the luminance setting value of the display apparatus of FIG. 1 is a first value. FIG. 13 is a diagram illustrating the data power voltage AVDD, the maximum data voltage VDMAX, the minimum data voltage VDMIN, the first power voltage ELVDD, the second power voltage ELVSS and the reference voltage VREF when the luminance setting value of the display apparatus of FIG. 1 is a second value. FIG. 14 is a diagram illustrating the data power voltage AVDD, the maximum data voltage VDMAX, the minimum data voltage VDMIN, the first power voltage ELVDD, the second power voltage ELVSS and the reference voltage VREF when the luminance setting value of the display apparatus of FIG. 1 is a third value. FIG. 15 is a diagram illustrating the data power voltage AVDD, the maximum data voltage VDMAX, the minimum data voltage VDMIN, the first power voltage ELVDD, the second power voltage ELVSS and the reference voltage VREF when the luminance setting value of the display apparatus of FIG. 1 is a fourth value.

For example, the first value of FIG. 12 may be greater than the second value of FIG. 13, the second value of FIG. 13 may be greater than the third value of FIG. 14 and the third value of FIG. 14 may be greater than the fourth value of FIG. 15. For example, the first value may be 1000 nit, the second value may be 500 nit, the third value may be 100 nit and the fourth value may be 10 nit.

For example, the luminance mode may be an ultra high luminance mode when the luminance setting value of the display apparatus is the first value of FIG. 12. For example, the luminance mode may be a high luminance mode when the luminance setting value of the display apparatus is the second value of FIG. 13. For example, the luminance mode may be a medium luminance mode when the luminance setting value of the display apparatus is the third value of FIG. 14. For example, the luminance mode may be a low luminance mode when the luminance setting value of the display apparatus is the fourth value of FIG. 15.

Referring to FIGS. 1 to 15, when the luminance setting value varies, the data power voltage AVDD and the maximum data voltage VDMAX may also vary. In contrast, when the luminance setting value varies, the minimum data voltage VDMIN may be fixed.

For example, as the luminance setting value increases, the data power voltage AVDD and the maximum data voltage VDMAX may increase. In contrast, as the luminance setting value decreases, the data power voltage AVDD and the maximum data voltage VDMAX may decrease. The data power voltage AVDD may decrease when the luminance setting value decreases, so that a power consumption of the data driver 500 may be reduced when the luminance setting value decreases.

When the luminance setting value varies, a difference between the data power voltage AVDD and the maximum data voltage VDMAX may be fixed. For example, the difference between the data power voltage AVDD and the maximum data voltage VDMAX may be a first fixed voltage difference VF1. The data power voltage AVDD may be greater than the maximum data voltage VDMAX.

The maximum data voltage VDMAX may be greater than the first power voltage ELVDD of the pixel or less than the first power voltage ELVDD of the pixel.

FIGS. 12 and 13 illustrate cases in which the maximum data voltage VDMAX is greater than the first power voltage ELVDD of the pixel. FIGS. 14 and 15 illustrate cases in which the maximum data voltage VDMAX is less than the first power voltage ELVDD of the pixel.

When the luminance setting value varies, a difference between the reference voltage VREF and the minimum data voltage VDMIN may be fixed. For example, the difference between the reference voltage VREF and the minimum data voltage VDMIN may be a second fixed voltage difference VF2. When the luminance setting value varies, the minimum data voltage VDMIN may be fixed and the difference between the reference voltage VREF and the minimum data voltage VDMIN may be fixed so that the reference voltage VREF may also be fixed. The reference voltage VREF may be greater than the minimum data voltage VDMIN.

In addition, the minimum data voltage VDMIN may be greater than the second power voltage ELVSS.

The maximum data voltage VDMAX may mean a maximum value of the data voltage outputted by the data driver 500 at a specific luminance setting value. The minimum data voltage VDMIN may mean a minimum value of the data voltage outputted by the data driver 500 at the specific luminance setting value.

A maximum capability of the data voltage which the data driver 500 is capable of outputting regardless of the luminance setting value may be referred to as IC Analog Max. A minimum capability of the data voltage which the data driver 500 is capable of outputting regardless of the luminance setting value may be referred to as IC Analog Min.

The maximum data voltage VDMAX may be greater than the white data voltage corresponding to the maximum grayscale value (e.g. 255) at the specific luminance setting value.

When the luminance setting value varies, a difference between the maximum data voltage VDMAX and the white data voltage may be fixed. For example, the difference between the maximum data voltage VDMAX and the white data voltage may be a third fixed voltage difference VF3.

Ideally, the white data voltage may be set same as the maximum data voltage VDMAX. However, practically, the white data may need to be compensated according to a process deviation of the display panel 100, a deterioration of the display panel 100 and so on. Thus, a compensation margin may be obtained by setting the maximum data voltage VDMAX to be greater than the white data voltage.

In contrast, the minimum data voltage VDMIN corresponding to the minimum grayscale value (zero) may be set same as the black data voltage.

For example, a gamma lookup table GLUT may have values of thirteen bits in FIGS. 12 to 15 and an interval between the maximum data voltage VDMAX and the minimum data voltage VDMIN may be divided into 8192 analog points. Herein, the maximum data voltage VDMAX has a value of 8191 and the minimum data voltage VDMIN has a value of zero. The white data voltage corresponding to the maximum grayscale value (e.g. 255) may have a value of 8000 considering the compensation margin. The black data voltage may have a value of zero same as the minimum data voltage VDMIN.

The luminance setting value of FIG. 13 is less than the luminance setting value of FIG. 12 so that the maximum data voltage VDMAX of FIG. 13 may be less than the maximum data voltage VDMAX of FIG. 12. In addition, the data power voltage AVDD of FIG. 13 may be less than the data power voltage AVDD of FIG. 12. As explained above, the data power voltage AVDD may decrease when the luminance setting value decreases, so that a power consumption of the display apparatus may be reduced.

In addition, the maximum data voltage VDMAX of FIG. 13 is less than the maximum data voltage VDMAX of FIG. 12, while the number of analog points (e.g. 8192) between the maximum data voltage VDMAX and the minimum data voltage VDMIN according to the number of bits (e.g. 13 bits) of the gamma lookup table GLUT is same in FIGS. 12 and 13. Thus, when the luminance setting value decreases, a unit voltage difference between the adjacent analog points and a voltage control precision of the data voltage VDATA may be increased.

The driving current of the pixel may be proportional to the square of the difference between the data voltage VDATA and the reference voltage VREF and the luminance of the pixel may be determined by a potential difference between the data voltage and the reference voltage VREF. In the data voltage VDATA, white may indicate a direction in which the voltage increases and black may indicate a direction in which the voltage decreases.

Hereinafter, steps of setting the data power voltage AVDD, the maximum data voltage VDMAX, the minimum data voltage VDMIN, the first power voltage ELVDD, the second power voltage ELVSS and the reference voltage VREF are explained.

In a first step, the black data voltage may be set to a voltage at which a luminance of a black image is less than 0.005 nit. The black data voltage may be determined by an off characteristic of the first transistor T1 and may have a fixed value without varying according to the luminance setting value. Thus, the black data voltage does not need to be changed and the black data voltage is a lowest voltage among the data voltages so that the black data voltage may be fixed to the minimum data voltage VDMIN (IC Analog Min. of FIG. 12). The minimum value VDMIN of the data voltage generated by the data voltage 500 at the specific luminance setting value may be fixed to IC Analog Min. which is the minimum capability of the data voltage which the data driver 500 is capable of outputting regardless of a luminance.

In a second step, after fixing the black data voltage to the minimum data voltage VDMIN (IC Analog Min. of FIG. 12), the reference voltage VREF may be fixed to a voltage at which the luminance of the black image may be determined to be less than 0.005 nit.

In a third step, the white data voltage is set to vary according to the luminance setting values (e.g. 1000 nit, 500 nit, 100 nit, 10 nit, and so on). As the white data voltage varies according to the luminance setting values (e.g. 1000 nit, 500 nit, 100 nit, 10 nit, and so on), the maximum data voltage VDMAX may also be set to vary. As the luminance setting value increases, the white data voltage has to increase. Thus, when the luminance setting value is a maximum luminance setting value (e.g. 1000 nit), the maximum data voltage VDMAX may be determined as the IC Analog Max. When the luminance setting value is less than the maximum luminance setting value (e.g. 1000 nit), the maximum data voltage VDMAX may be lowered from the IC Analog Max. For example, the maximum data voltage VDMAX in the luminance setting value of 500 nit may be less than the maximum data voltage VDMAX in the luminance setting value of 1000 nit. For example, the maximum data voltage VDMAX in the luminance setting value of 100 nit may be less than the maximum data voltage VDMAX in the luminance setting value of 500 nit.

In a fourth step, the data power voltage AVDD is a reference power of the data driver 500 so that the data power voltage AVDD may be properly set according to operation characteristics of the data driver 500. For example, the data power voltage AVDD may be set to be greater than the maximum data voltage VDMAX by 0.3V. Accordingly, as the luminance setting value decreases, the maximum data voltage VDMAX may decrease and the data power voltage AVDD may also decrease. As the data power voltage AVDD decreases, the power consumption of the data driver 500 may be reduced.

In the present embodiment, the driving controller 200 may control an operation of the data driver 500 and an operation of the power voltage generator 400. The driving controller 200, the power voltage generator 400 and the data driver 500 may be independently formed.

The driving controller 200 may output a luminance setting value DBV to the power voltage generator 400. The power voltage generator 400 may generate the data power voltage AVDD and the maximum data voltage VDMAX which are varied according to the luminance setting value DBV and output the data power voltage AVDD and the maximum data voltage VDMAX to the data driver 500. The power voltage generator 400 may generate the minimum data voltage VDMIN which is not varied according to the luminance setting value DBV but fixed and output the minimum data voltage VDMIN to the data driver 500.

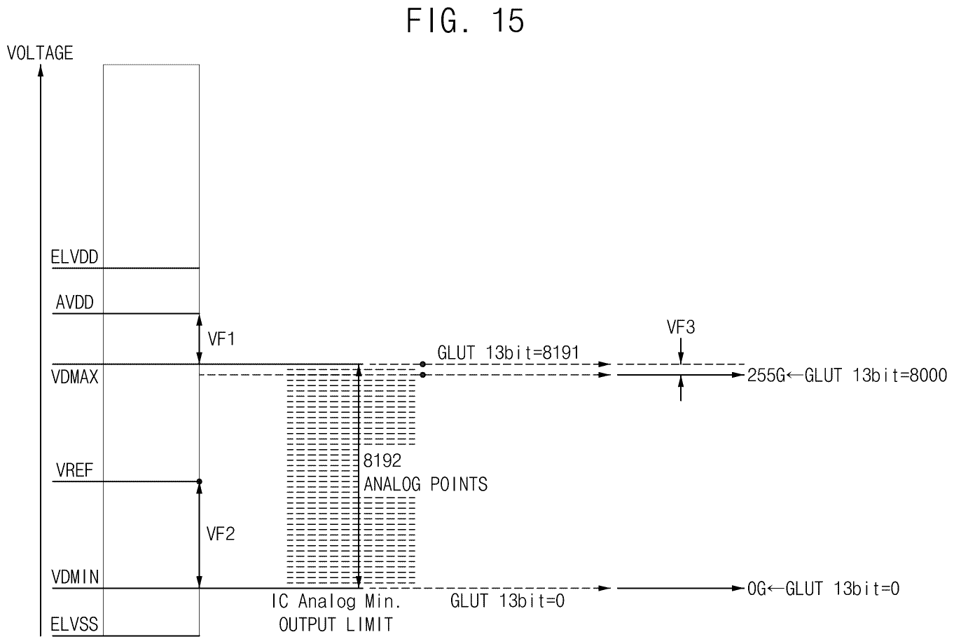

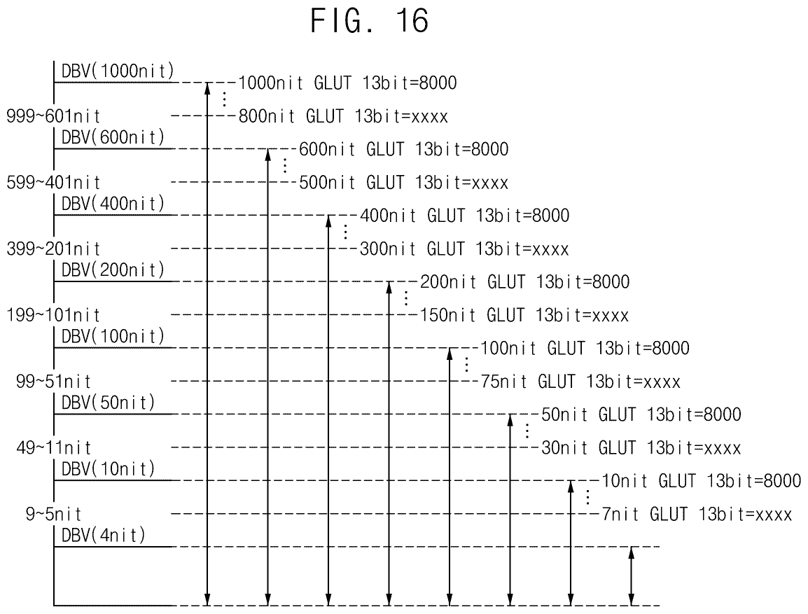

FIG. 16 is a diagram illustrating a setting of the gamma lookup table GLUT according to the luminance setting value DBV of the display apparatus of FIG. 1.

Referring to FIGS. 1 to 16, as a number of luminance setting steps increases, a number of varying steps of the data power voltage AVDD may increase. For example, the number of luminance setting steps may be eight in FIG. 16. In a first luminance setting step, the luminance setting value DBV may be 1000 nit. In a second luminance setting step, the luminance setting value DBV may be 600 nit. In a third luminance setting step, the luminance setting value DBV may be 400 nit. In a fourth luminance setting step, the luminance setting value DBV may be 200 nit. In a fifth luminance setting step, the luminance setting value DBV may be 100 nit. In a sixth luminance setting step, the luminance setting value DBV may be 50 nit. In a seventh luminance setting step, the luminance setting value DBV may be 10 nit. In an eighth luminance setting step, the luminance setting value DBV may be 4 nit.

As illustrated above, the white data voltage corresponding to the maximum grayscale value (e.g. 255) may have the value of 8000 in each of the luminance setting steps.

When the luminance setting value DBV is between luminance setting values of the luminance setting steps, the white data voltage may not be set to 8000 but only the values of the gamma lookup table GLUT may be changed.

For example, when the luminance setting value DBV is 800 nit between 1000 nit of the first luminance setting step and 600 nit of the second luminance setting step, the white data voltage may not be reset to 8000 for the luminance setting value DBV of 800 nit. Thus, the white data voltage may be set to a specific value less than 8000 in the gamma lookup table GLUT corresponding to the luminance step value of 1000 nit.

Similarly, when the luminance setting value DBV is 500 nit between 600 nit of the second luminance setting step and 400 nit of the third luminance setting step, the white data voltage may not be reset to 8000 for the luminance setting value DBV of 500 nit. Thus, the white data voltage may be set to a specific value less than 8000 in the gamma lookup table GLUT corresponding to the luminance step value of 600 nit.

FIG. 17 is a diagram illustrating an example of a driving timing of the display panel 100 of FIG. 1.

Referring to FIGS. 1 to 17, the driving timing may include a plurality of frames FR1 and FR2, sometimes referred to as first and second frames FR1 and FR2, respectively. Each frame FR1 and FR2 may include an active period AC1 and AC2, sometimes referred to as first and second active periods AC1 and AC2, respectively, and a blank period BL1 and BL2, sometimes referred to as first and second blank periods BL1 and BL2, respectively.

The first frame FR1 may include the first active period AC1 and the first blank period BL1. The second frame FR2 may include the second active period AC2 and the second blank period BL2.

FIG. 17 illustrates a case in which the display panel 100 is driven in a fixed frequency. Thus, the first frame FR1 and the second frame FR2 may have the same length. The first active period AC1 and the second active period AC2 may have the same length. The first blank period BL1 and the second blank period BL2 may have the same length.

In the active periods AC1 and AC2, the gate signals GW, GB and GR and the emission signals EM1 and EM2 may be sequentially applied to the pixel rows. In the blank periods BL1 and BL2, the gate signals GW, GB and GR and the emission signals EM1 and EM2 may not be applied to the pixel rows.

In the present embodiment, the maximum data voltage VDMAX and the data power voltage AVDD may be varied in a unit of a frame according to the luminance setting value DBV.

The maximum data voltage VDMAX and the data power voltage AVDD may be changed in the blank periods BL1 and BL2.

When an interface between the power voltage generator 400 and the data driver 500 is I2C (inter integrated circuit) interface, it may need a voltage setting time of about 30 μs corresponding to a time of about 20 horizontal line periods.

When SPMI (system power management interface) is used for the interface between the power voltage generator 400 and the data driver 500, the voltage setting time may be decreased to under 2 μs.

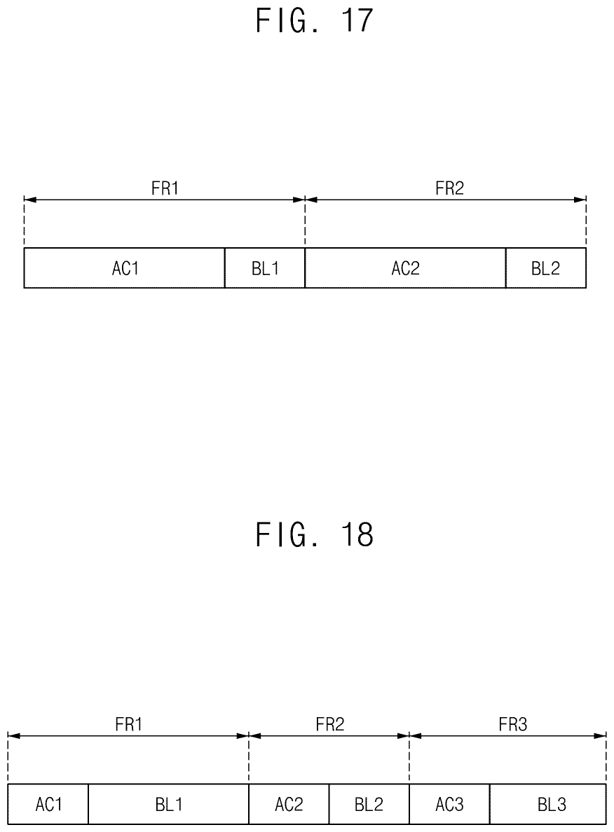

FIG. 18 is a diagram illustrating an example of a driving timing of the display panel 100 of FIG. 1.

Referring to FIGS. 1 to 18, the driving timing may include a plurality of frames FR1, FR2 and FR3, sometimes referred to as first, second, and third frames FR1, FR2, and FR3, respectively. Each frame FR1, FR2 and FR3 may include an active period AC1, AC2 and AC3, sometimes referred to as first, second, and third active periods AC1, AC2, and AC3, respectively, and a blank period BL1, BL2 and BL3 sometimes referred to as first, second, and third blank periods BL1, BL2, and BL3, respectively.

FIG. 18 illustrates a case in which the display panel 100 is driven in a variable frequency. The first frame FR1 having a first frequency may include the first active period AC1 and the first blank period BL1. The second frame FR2 having a second frequency different from the first frequency may include the second active period AC2 and the second blank period BL2. The third frame FR3 having a third frequency different from the first frequency and the second frequency may include the third active period AC3 and the third blank period BL3.

The first active period AC1 may have a length substantially the same as a length of the second active period AC2. The first blank period BL1 may have a length different from a length of the second blank period BL2.

The second active period AC2 may have the length substantially the same as a length of the third active period AC3. The second blank period BL2 may have the length different from a length of the third blank period BL3.

The display apparatus supporting the variable frequencies may include a writing frame in which the data voltage is written to the pixel and a holding frame in which only light emission is operated without writing the data voltage to the pixel. The writing frame may be in the active period AC1, AC2 and AC3. The holding frame may be in the blank period BL1, BL2 and BL3.

For example, in the writing frame, the data voltage VDATA may be applied to the first transistor T1 and the light emitting element EE may emit a light. For example, in the holding frame, the data voltage VDATA may not be applied to the first transistor T1 and the light emitting element EE may emit a light.

In the present embodiment, the maximum data voltage VDMAX and the data power voltage AVDD may be varied in a unit of a frame according to the luminance setting value DBV. The maximum data voltage VDMAX and the data power voltage AVDD may be changed in the blank periods BL1, BL2 and BL3.

According to the present embodiment, the driving current of the pixel may be determined proportionally to the square of the difference between the data voltage VDATA and the reference voltage VREF, the data voltage may increase as image data becomes whiter (brighter) and the data voltage may decrease as the image data becomes blacker (darker).

The data power voltage AVDD and the maximum data voltage VDMAX may be varied according to the luminance setting value DBV or the luminance mode of the display apparatus and the minimum data voltage VDMIN may be fixed regardless of the luminance setting value DBV or the luminance mode of the display apparatus.

The data power voltage AVDD and the maximum data voltage VDMAX are varied according to the luminance setting value DBV or the luminance mode so that the white data voltage and the data power voltage AVDD may be set relatively low when the luminance setting value DBV is relatively low or the luminance mode is a low luminance mode. Thus, the power consumption of the display apparatus may be reduced.

When the fifth transistor T5 and the sixth transistor T6 of the pixel are P-type transistors, relatively low voltages may be used for the active levels and the inactive levels of the emission signals EM1 and EM2 so that the power consumption of the display apparatus may be further reduced.

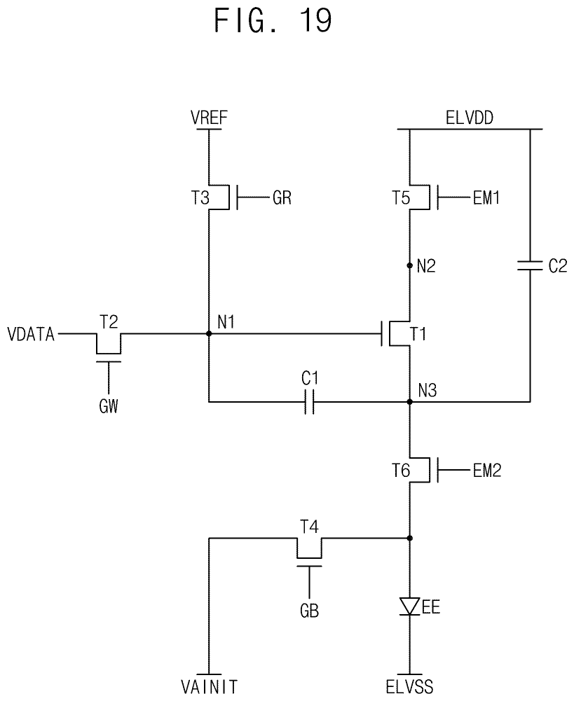

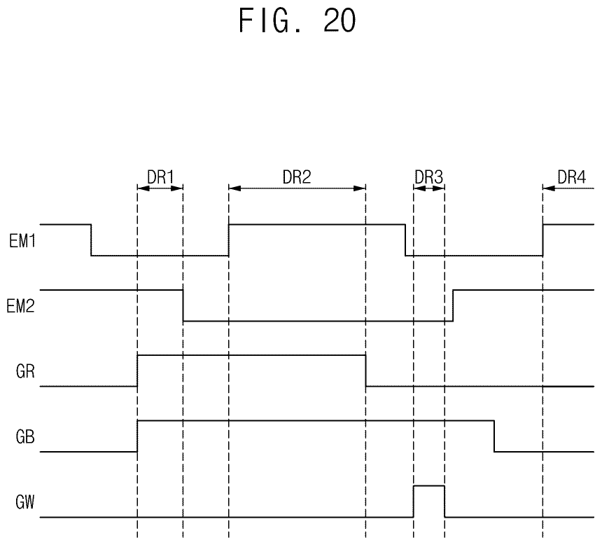

FIG. 19 is a circuit diagram illustrating a pixel of a display panel 100 of a display apparatus according to an embodiment of the present inventive concept. FIG. 20 is a timing diagram illustrating input signals applied to the pixel of FIG. 19.

The display apparatus according to the present embodiment is substantially the same as the display apparatus of the previous embodiment explained referring to FIGS. 1 to 18 except that the fifth transistor T5 and the sixth transistor T6 are N-type transistors. Thus, the same reference numerals will be used to refer to the same or like parts as those described in the previous embodiment of FIGS. 1 to 18 and any repetitive explanation concerning the above elements will be omitted.

Referring to FIGS. 1 and 12 to 20, the display panel 100 includes a plurality of pixels. Each of the pixels includes a light emitting element EE. The pixels may emit a light based on a first power voltage ELVDD and a second power voltage ELVSS less than the first power voltage ELVDD.

The pixel receives a writing gate signal GW, an initialization gate signal GB, a reference gate signal GR, the data voltage VDATA, a first emission signal EM1 and a second emission signal EM2 and the light emitting element EE emits a light according to a level of the data voltage VDATA to display an image.

The pixel includes the light emitting element EE and a first transistor T1 applying a driving current to the light emitting element EE. Herein, the first transistor T1 may be an N-type transistor. The first transistor T1 may be an oxide semiconductor thin film transistor.

The driving current of the pixel may be proportional to a square of a difference between the data voltage VDATA and a reference voltage VREF. The reference voltage VREF may be different from the first power voltage ELVDD. The reference voltage VREF may be different from the second power voltage ELVSS.

The pixel may include the first transistor T1, a second transistor T2, a third transistor T3, a fourth transistor T4, a fifth transistor T5, a sixth transistor T6, the light emitting element EE, a first capacitor C1 and a second capacitor C2. The first transistor T1 includes a control electrode connected to a first node N1, a first electrode connected to a second node N2 and a second electrode connected to a third node N3. The second transistor T2 includes a control electrode receiving the writing gate signal GW, a first electrode receiving the data voltage VDATA and a second electrode connected to the first node N1. The third transistor T3 includes a control electrode receiving the reference gate signal GR, a first electrode receiving the reference voltage VREF and a second electrode connected to the first node N1. The fourth transistor T4 includes a control electrode receiving the initialization gate signal GB, a first electrode receiving an initialization voltage VAINIT and a second electrode connected to an anode electrode of the light emitting element EE. The fifth transistor T5 includes a control electrode receiving the first emission signal EM1, a first electrode receiving the first power voltage ELVDD and a second electrode connected to the second node N2. The sixth transistor T6 includes a control electrode receiving the second emission signal EM2, a first electrode connected to the third node N3 and a second electrode connected to the anode electrode of the light emitting element EE. The light emitting element EE includes the anode electrode and a cathode electrode receiving the second power voltage ELVSS. The first capacitor C1 includes a first electrode connected to the first node N1 and a second electrode connected to the third node N3. The second capacitor C2 includes a first electrode receiving the first power voltage ELVDD and a second electrode connected to the third node N3.

In the present embodiment, the second transistor T2, the third transistor T3, the fourth transistor T4, the fifth transistor T5 and the sixth transistor T6 may be N-type transistors. The second transistor T2, the third transistor T3, the fourth transistor T4, the fifth transistor T5 and the sixth transistor T6 may be oxide semiconductor thin film transistors.

In the present embodiment, all of the first to sixth transistors T1 to T6 are N-type transistors, so that a manufacturing process of the display panel 100 may be simplified and accordingly, a manufacturing cost of the display apparatus may be reduced.

According to the present embodiment, the driving current of the pixel may be determined proportionally to the square of the difference between the data voltage VDATA and the reference voltage VREF, the data voltage may increase as image data becomes whiter (brighter) and the data voltage may decrease as the image data becomes blacker (darker).

The data power voltage AVDD and the maximum data voltage VDMAX may be varied according to the luminance setting value DBV or the luminance mode of the display apparatus and the minimum data voltage VDMIN may be fixed regardless of the luminance setting value DBV or the luminance mode of the display apparatus.

The data power voltage AVDD and the maximum data voltage VDMAX are varied according to the luminance setting value DBV or the luminance mode so that the white data voltage and the data power voltage AVDD may be set relatively low when the luminance setting value DBV is relatively low or the luminance mode is a low luminance mode. Thus, the power consumption of the display apparatus may be reduced.

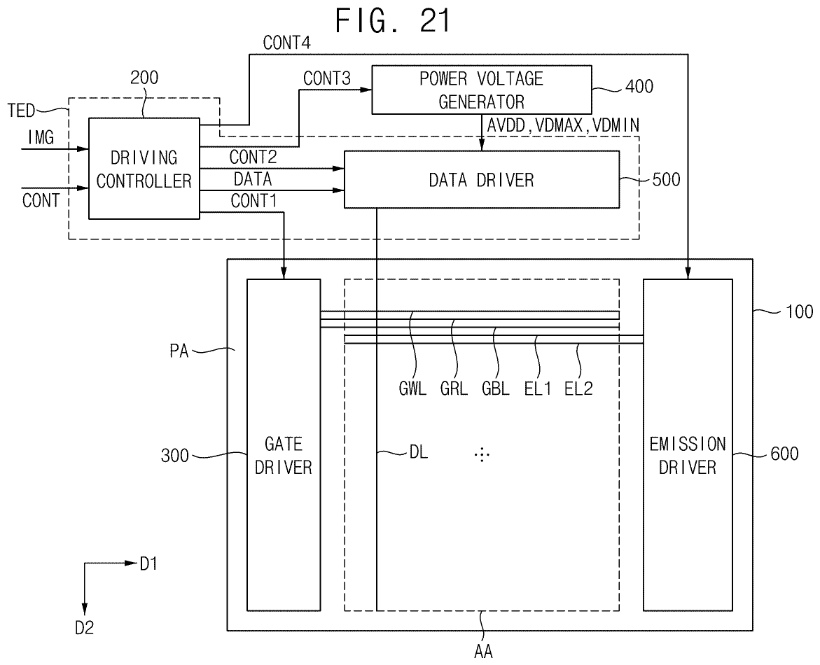

FIG. 21 is a block diagram illustrating a display apparatus according to an embodiment of the present inventive concept.

The display apparatus according to the present embodiment is substantially the same as the display apparatus of the previous embodiment explained referring to FIGS. 1 to 18 except that the driving controller and the data driver are integratedly formed. Thus, the same reference numerals will be used to refer to the same or like parts as those described in the previous embodiment of FIGS. 1 to 18 and any repetitive explanation concerning the above elements will be omitted.

Referring to FIGS. 2 to 18 and 21, the driving controller 200 may control an operation of the data driver 500 and an operation of the power voltage generator 400. The driving controller 200 and the data driver 500 may be integratedly formed so that the driving controller 200 and the data driver 500 may form an integrated driver TED. A driving module including at least the driving controller 200 and the data driver 500 which are integratedly formed may be referred to a timing controller embedded data driver.

The power voltage generator 400 may be independently formed from the integrated driver TED.

The integrated driver TED may output the luminance setting value DBV to the power voltage generator 400. The power voltage generator 400 may generate the data power voltage AVDD and the maximum data voltage VDMAX which are varied according to the luminance setting value DBV and output the data power voltage AVDD and the maximum data voltage VDMAX to the integrated driver TED. The power voltage generator 400 may generate the minimum data voltage VDMIN which is not varied according to the luminance setting value DBV but fixed and output the minimum data voltage VDMIN to the integrated driver TED.

According to the present embodiment, the driving current of the pixel may be determined proportionally to the square of the difference between the data voltage VDATA and the reference voltage VREF, the data voltage may increase as image data becomes whiter (brighter) and the data voltage may decrease as the image data becomes blacker (darker).

The data power voltage AVDD and the maximum data voltage VDMAX may be varied according to the luminance setting value DBV or the luminance mode of the display apparatus and the minimum data voltage VDMIN may be fixed regardless of the luminance setting value DBV or the luminance mode of the display apparatus.

The data power voltage AVDD and the maximum data voltage VDMAX are varied according to the luminance setting value DBV or the luminance mode so that the white data voltage and the data power voltage AVDD may be set relatively low when the luminance setting value DBV is relatively low or the luminance mode is a low luminance mode. Thus, the power consumption of the display apparatus may be reduced.

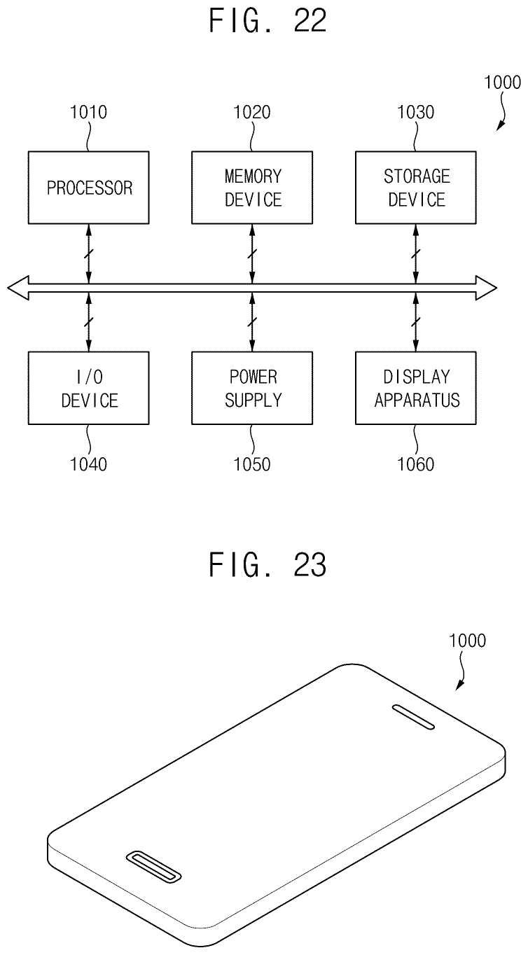

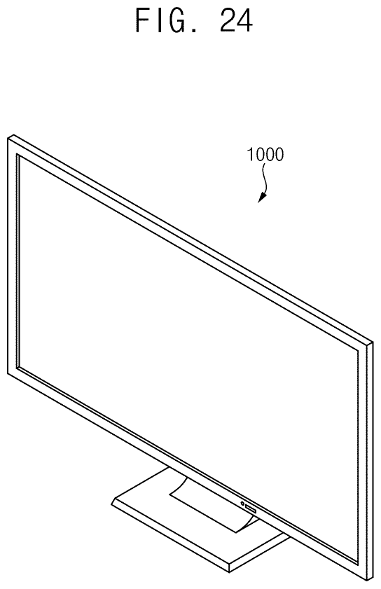

FIG. 22 is a block diagram illustrating an electronic apparatus 1000 according to an embodiment of the present inventive concept. FIG. 23 is a diagram illustrating an example in which the electronic apparatus 1000 of FIG. 22 is implemented as a smartphone. FIG. 24 is a diagram illustrating an example in which the electronic apparatus 1000 of FIG. 22 is implemented as a monitor.

Referring to FIGS. 22 to 24, the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, etc.

In an embodiment, as illustrated in FIG. 23, the electronic apparatus 1000 may be implemented as a smartphone. In an embodiment, as illustrated in FIG. 24, the electronic apparatus 1000 may be implemented as a monitor. However, the electronic apparatus 1000 is not limited thereto. For example, the electronic apparatus 1000 may be implemented as a television, a cellular phone, a video phone, a smart pad, a smart watch, a tablet PC, a car navigation system, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1. The processor 1010 may also be referred to a host.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

According to the embodiments of the display apparatus and the electronic apparatus including the display apparatus, the power consumption of the display apparatus may be reduced.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

What is claimed is:

1. A display apparatus comprising:
a display panel including a pixel configured to emit a light based on a first power voltage and a second power voltage less than the first power voltage;
a data driver configured to output a data voltage to the pixel; and
a power voltage generator configured to output a data power voltage, a maximum data voltage and a minimum data voltage to the data driver,
wherein a luminance setting value varies, and the data power voltage and the maximum data voltage are varied, and
the minimum data voltage is fixed.

2. The display apparatus of claim 1, wherein the luminance setting value varies, and a difference between the data power voltage and the maximum data voltage is fixed.

3. The display apparatus of claim 2, wherein the data power voltage is greater than the maximum data voltage.

4. The display apparatus of claim 1, wherein the luminance setting value varies, and a difference between a reference voltage applied to the pixel and the minimum data voltage is fixed.

5. The display apparatus of claim 4, wherein the reference voltage is different from the first power voltage, and
wherein the reference voltage is different from the second power voltage.

6. The display apparatus of claim 4, wherein the reference voltage is greater than the minimum data voltage.

7. The display apparatus of claim 6, wherein the minimum data voltage is greater than the second power voltage.

8. The display apparatus of claim 1, wherein the maximum data voltage is greater than a white data voltage corresponding to a maximum grayscale value at the luminance setting value.

9. The display apparatus of claim 8, wherein the luminance setting value varies, and a difference between the maximum data voltage and the white data voltage is fixed.

10. The display apparatus of claim 8, wherein the minimum data voltage is substantially the same as a black data voltage corresponding to a minimum grayscale value.

11. The display apparatus of claim 1, wherein the pixel includes a light emitting element and a first transistor configured to apply a driving current to the light emitting element, and
wherein the first transistor is an N-type transistor.

12. The display apparatus of claim 11, wherein the driving current of the pixel is proportional to a square of a difference between the data voltage and a reference voltage applied to the pixel.

13. The display apparatus of claim 11, wherein the pixel comprises:
the first transistor including a control electrode connected to a first node, a first electrode connected to a second node and a second electrode connected to a third node;
a second transistor including a control electrode configured to receive a writing gate signal, a first electrode configured to receive the data voltage and a second electrode connected to the first node;
a third transistor including a control electrode configured to receive a reference gate signal, a first electrode configured to receive a reference voltage and a second electrode connected to the first node;
a fourth transistor including a control electrode configured to receive an initialization gate signal, a first electrode configured to receive an initialization voltage and a second electrode connected to an anode electrode of the light emitting element;
a fifth transistor including a control electrode configured to receive a first emission signal, a first electrode configured to receive the first power voltage and a second electrode connected to the second node;
a sixth transistor including a control electrode configured to receive a second emission signal, a first electrode connected to the third node and a second electrode connected to the anode electrode of the light emitting element;
the light emitting element including the anode electrode and a cathode electrode configured to receive the second power voltage;
a first capacitor including a first electrode connected to the first node and a second electrode connected to the third node; and
a second capacitor including a first electrode configured to receive the first power voltage and a second electrode connected to the third node.

14. The display apparatus of claim 13, wherein the second transistor, the third transistor and the fourth transistor are N-type transistors, and
wherein at least one of the fifth transistor and the sixth transistor is P-type transistor.

15. The display apparatus of claim 13, wherein the second transistor, the third transistor, the fourth transistor, the fifth transistor and the sixth transistor are N-type transistors.

16. The display apparatus of claim 13, wherein the first emission signal has an inactive level in a first period, wherein the second emission signal has an active level in the first period, wherein the reference gate signal has an active level in the first period, wherein the initialization gate signal has an active level in the first period, and wherein the writing gate signal has an inactive level in the first period,
wherein the first emission signal has an active level in a second period subsequent to the first period, wherein the second emission signal has an inactive level in the second period, wherein the reference gate signal has the active level in the second period, wherein the initialization gate signal has the active level in the second period, and wherein the writing gate signal has the inactive level in the second period,
wherein the first emission signal has the inactive level in a third period subsequent to the second period, wherein the second emission signal has the inactive level in the third period, wherein the reference gate signal has an inactive level in the third period, wherein the initialization gate signal has the active level in the third period, and wherein the writing gate signal has an active level in the third period,
wherein the first emission signal has the active level in a fourth period subsequent to the third period, wherein the second emission signal has the active level in the fourth period, wherein the reference gate signal has the inactive level in the fourth period, wherein the initialization gate signal has the inactive level in the fourth period, and wherein the writing gate signal has the inactive level in the fourth period.

17. The display apparatus of claim 1, further comprising a driving controller configured to control an operation of the data driver and an operation of the power voltage generator,
wherein the driving controller is configured to output the luminance setting value to the power voltage generator.

18. The display apparatus of claim 17, wherein the driving controller and the data driver are integratedly formed to form an integrated driver,
wherein the integrated driver is configured to output the luminance setting value to the power voltage generator, and
wherein the power voltage generator is configured to output the data power voltage, the maximum data voltage and the minimum data voltage to the integrated driver.

19. A display apparatus comprising:
a display panel including a pixel configured to emit a light based on a first power voltage and a second power voltage less than the first power voltage;
a data driver configured to output a data voltage to the pixel; and
a power voltage generator configured to output a data power voltage, a maximum data voltage and a minimum data voltage to the data driver,
wherein a luminance mode varies, and the data power voltage and the maximum data voltage are varied, and
the minimum data voltage is fixed.

20. An electronic apparatus comprising:
a display panel including a pixel configured to emit a light based on a first power voltage and a second power voltage less than the first power voltage;
a data driver configured to output a data voltage to the pixel;
a power voltage generator configured to output a data power voltage, a maximum data voltage and a minimum data voltage to the data driver;
a driving controller configured to control an operation of the data driver and an operation of the power voltage generator; and
a processor configured to output an input control signal and input image data to the driving controller,
wherein a luminance setting value varies, and the data power voltage and the maximum data voltage are varied, and
the minimum data voltage is fixed.
